(19) United States
(12) Patent Application Publication
(10) Pub. No.: US 2006/0268550 A1
(43) Pub. Date: Nov. 30, 2006

(54) High-power LED lamp having heat dissipation assembly

(76) Inventor: Kuang-Tseng Lin, Taipei (TW)

Correspondence Address: LEONG C LEI, PMB # 1008, 1867 YGNACIO VALLEY ROAD, WALNUT CREEK, CA, 94598, US

(21) Appl. No.: 11/135,422

(22) Filed: May 24, 2005

(51) Int. Cl. F21V 29/00

(52) U.S. Cl. 362/294

(57) ABSTRACT

A high-power LED lamp having a heat dissipation assembly is provided. The heat generated by a lamp made of a large number of gathered LEDs is quickly and evenly conducted and dissipated, so the lamp could be cooled down effectively and the LEDs, even though housed in an air-tight space and operated for an extended period time under a high power, could be protected from the excessive heat.

### BACKGROUND OF THE INVENTION

(a) Technical Field of the Invention

The present invention generally relates to LED lamps, and more specifically to a high-power lamp having a heat dissipation assembly.

(b) Description of the Prior Art

For the past several decades, lamps have evolved from the incandescent light bulbs to fluorescent light tubes on to the currently popular energy-saving light tubes (such as the PL lamps) or bulbs (such as light bulbs with ballast). Despite the progress of the lamps, high-power and high brightness lamps still suffer the traditional problem of heat dissipation. As these lamps, especially road lamps and projecting lamps, are often operated in an air-tight space and under a rigorous condition, excessive heat is continuously accumulated in the air-tight space, and the reliability and safety of the lamps are thereby compromised.

Recently light emitting diodes (LEDs) have been applied in these high-power road lamps or projecting lamps, due to the LEDs' high brightness, long projection range, and most importantly, low power consumption and high energy saving.

However, these LED lamps are not immune from the heat dissipation problem of conventional lamps and, due to their characteristics, LED lamps are easily damaged from the excessive heat.

Accordingly, after numerous improvement attempts and experiments, the present invention is provided herein to obviate the foregoing shortcomings and disadvantages of conventional LED lamps.

### SUMMARY OF THE INVENTION

The primary purpose of the present invention is to provide a LED lamp with a heat dissipation assembly such that, if the LED lamp is operated in an air-tight space and under a rigorous condition, the LED lamp is protected from the excessive heat accumulated in the air-tight space. The present invention of course could be applied to LED lamps operated in an open environment with an even better performance, as the air convection already provides some degree of heat dissipation.

The present invention utilizes a heat conducting plastic pad attached to a heat dissipation plate, both having a large planar surface area. The heat generated by LED a lamp made of a large number of gathered LEDs is quickly and evenly conducted and extracted by the heat conducting plate, and then dissipated evenly and quickly via the large surface area of the heat dissipation plate, so the lamp could be cooled down effectively and the LEDs, even though housed in an air-tight space and operated for an extended period time under a high power, could be protected from the excessive heat.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side view of a LED used in the present invention.

FIG. 2 is a perspective view showing the high-power LED lamp according to an embodiment of the present invention.

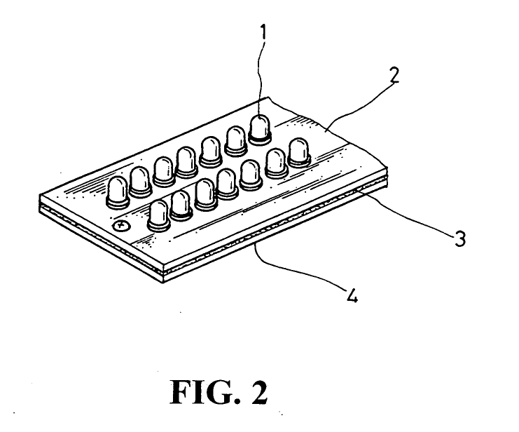

FIG. 3 is a perspective explosion view showing the various components of the LED lamp of FIG. 2.

FIG. 4 is a sectional view showing the LED lamp of FIG. 2.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

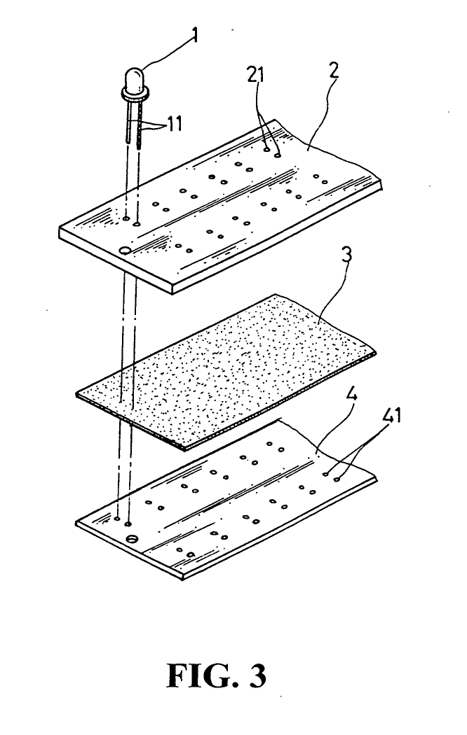

As illustrated in FIG. 3, the present invention mainly contains a plurality of LEDs 1, a heat dissipation plate 2, a heat conducting pad 3, and a base plate 4.

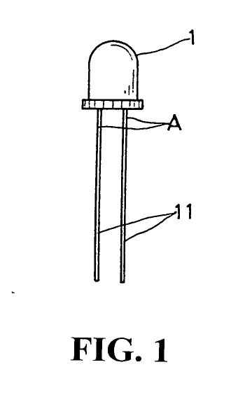

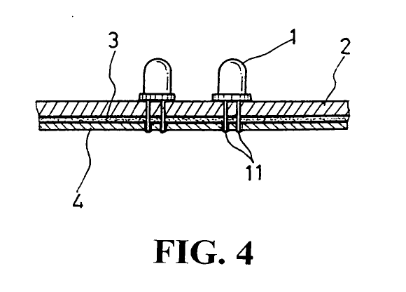

The LEDs 1 are of a high brightness type, and the LEDs 1 are gathered and positioned uniformly on a side of the heat dissipation plate 2 so as to form a planar and projecting light source. The heat conducting pad 3 is interposed between the heat dissipation plate 2 and the base plate 4. Each of the LEDs 1 is installed by having each of its legs 11 (as shown in FIG. 1) threaded through a pre-determined through hole 21 of the heat dissipation plate 2, and another pre-determined through hole 41 of the base plate 4 at a corresponding location to the through hole 21, directly piercing through the interposed heat conducting pad 3. The legs 11 are then welded to the through holes 41, as shown in FIG. 4.

The heat conducting pad 3 is made of a soft plastic composite material such that, when it is pierced by the legs 11 of the LEDs 1, the legs 11 are tightly wrapped by the heat conducting pad 3 and, thereby, the heat generated by the LEDs 1 could be transferred to the heat conducting pad 3 via the legs 11.

Please refer to the FIG. 1 again. A top portion A of the legs 11 is where the heat of the LEDs 1 is generated. Due to the aforementioned tight wrapping of the legs 11 by the heat conducting pad 3, the heat at leg portion A is conducted by the heat conducting pad 3 and dissipated by the heat dissipation plate 2, which is made of a metallic material having a high heat conductivity. As the heat dissipation plate 2 has a large planar contact area with the heat conducting plate 3, the heat conducted by the heat conducting plate 3 therefore could be quickly and evenly dissipated by the large surface area of the heat dissipation plate 2.

Accordingly, the present invention, with a utilization of a simple yet effective assembly, achieves satisfactorily and efficient heat dissipation for LED lamps.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high-power LED lamp having a heat dissipation assembly comprising:
a base plate;
a heat dissipation plate made of a metallic material having a high heat conductivity;
a heat conducting pad made of a soft plastic composite material interposed between said base plate and said heat dissipation plate;
a plurality of LEDs gathered and uniformly positioned on a side of said heat dissipation plate forming a planar light source by threading each of the legs of said plurality of LEDs through a first pre-determined through hole of said heat dissipation plate, said heat conducting pad, and a second predetermined through hole of said base plate at a corresponding location to said first through hole, and welding said leg to said second through hole;
wherein heat generated by said plurality of LEDs are conducted via said legs and said heat conducting plate, and dissipated by said heat dissipation plate.
